(19) United States
(12) Patent Application Publication
(10) Pub. No.: US 2005/0091041 A1
(43) Pub. Date: Apr. 28, 2005

(54) Method and system for speech coding

(75) Inventors: Anssi Ramo, Tampere (FI); Jani Nurminen, Tampere (FI); Sakari Himanen, Tampere (FI); Ari Heikkinen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/692,290

(22) Filed: Oct. 23, 2003

(51) Int. Cl. G10L 19/14

(52) U.S. Cl. 704/205

(57) ABSTRACT

A method and device for use in conjunction with an encoder for encoding an audio signal into a plurality of parameters. Based on the behavior of the parameters, such as pitch, voicing, energy and spectral amplitude information of the audio signal, the audio signal can be segmented, so that the parameter update rate can be optimized. The parameters of the segmented audio signal are recorded in a storage medium or transmitted to a decoder so as to allow the decoder to reconstruct the audio signal based on the parameters indicative of the segment audio signals. For example, based on the pitch characteristic, the pitch contour can be approximated by a plurality of contour segments. An adaptive downsampling method is used to update the parameters based on the contour segments so as to reduce the update rate. At the decoder, the parameters are updated at the original rate.

### CROSS REFERENCES TO RELATED APPLICATIONS

This application is related to U.S. patent application docket number 944-003.191, entitled “Method and System for Pitch Contour Quantization in Speech Coding”, which is assigned to the assignee of this application and filed even date herewith.

### FIELD OF THE INVENTION

The present invention relates generally to a speech coder and, more particularly, to a parametric speech coder for coding pre-recorded audio messages.

### BACKGROUND OF THE INVENTION

It will become required in the United States to take visually impaired persons into consideration when designing mobile phones. Manufactures of mobile phones must offer phones with a user interface suitable for a visually impaired user. In practice, this means that the menus are “spoken aloud” in addition to being displayed on the screen. It is obviously beneficial to store these audible messages in as little memory as possible. Typically, text-to-speech (TTS) algorithms have been considered for this application. However, to achieve reasonable quality TTS output, enormous databases are needed and, therefore, TTS is not a convenient solution for mobile terminals. With low memory usage, the quality provided by current TTS algorithms is not acceptable.

Besides TTS, a speech coder can be utilized to compress pre-recorded messages. This compressed information is saved and decoded in the mobile terminal to produce the output speech. For minimum memory consumption, very low bit rate coders are desirable alternatives. To generate the input speech signal to the coding system, either human speakers or high-quality (and high-complexity) TTS algorithms can be used.

While one underlying goal of speech coding is to achieve the best possible quality at a given coding rate, other performance aspects also have to be considered in developing a speech coder to a certain application. In addition to speech quality and bit rate, the main attributes include coder delay (defined mainly by the frame size plus a possible lookahead), complexity and memory requirements of the coder, sensitivity to channel errors, robustness to acoustic background noise, and the bandwidth of the coded speech. Also, a speech coder should be able to efficiently reproduce input signals with different energy levels and frequency characteristics.

Waveform-Matching and Parametric Speech Coding

The most common classification of speech coding systems divides them into two main categories of waveform coders and parametric coders. The waveform coders, as the name implies, are designed to preserve the waveform being coded directly without paying much attention to the characteristics of the speech signal. Thus, in waveform coders the reconstructed signal converges toward the original signal with decreasing quantization error. This perfect reconstruction property is not necessarily true for parametric coders, which use a priori information about the speech signal via different models and try to preserve the perceptually most important characteristics of speech rather than to code the actual waveform of it. In parametric coders the reconstruction error does not converge to zero with decreasing quantization error. Parametric coders are also called source coders or vocoders. Typically, parametric coders are used at low bit rates (1-6 kbits), whereas waveform-matching coders are used at higher bit rates.

In a typical parametric speech coder, the input speech signal is processed in fixed length segments or frames. Typically the frame length is about 10-30 ms, and a look-ahead segment of about 5-15 ms from the subsequent frame may also be available. The frame may further be divided into a number of sub-frames. For every frame, the encoder determines a parametric representation of the input signal. The parameters are quantized into a bitstream and transmitted through a communication channel or stored in a storage medium. At the receiving end, the decoder constructs a synthesized signal based on the received parameters. A typical speech coding system is shown in FIG. 1.

Parametric Speech Coding Model

A popular approach in parametric speech coding is to represent the speech signal or the vocal tract excitation signal by a sum of sine waves of arbitrary amplitudes, frequencies and phases:

$$s ( t ) = Re {\sum }_{m = 1}^{L ( t )} {a}_{m} ( t ) exp ( j [ {\int }_{0}^{t} {ω}_{m} ( t ) ⅆ t + {θ}_{m} ] ) , \qquad ( 1 )$$

where, for the mth sinusoidal component, αₘ, ωm (t) and θₘ represent the amplitude, frequency and a fixed phase offset. To obtain a frame-wise representation, the parameters are assumed to be constant over the analysis window. Thus, the discrete signal s(n) in a given frame is approximated by

$$s ( n ) = {\sum }_{m = 1}^{L} {A}_{m} cos ( n {ω}_{m} + {θ}_{m} ) , \qquad ( 2 )$$

where Aₘ and θₘ represent the amplitude and the phase of each sine-wave component associated with the frequency track ωₘ, and L is the number of sine-wave components. In the underlying sinusoidal model, the parameters to be transmitted are: the frequencies, the amplitudes, and the phases of the found sinusoidal components. The sinusoids are often assumed to be harmonically related at the multiple of the fundamental frequency ω₀ (=2πf₀). During voice speech 4 corresponds to speaker's pitch, but ω₀ has no physical meaning during unvoiced speech. In practical low bit rate sinusoidal coders, the parametric representation is usually different. The parameters to be transmitted typically include pitch (FIG. 2b), voicing (FIG. 2c), amplitude (e.g. linear prediction coefficients and excitation amplitudes) and the energy (FIG. 2d) of the speech signal (FIG. 2a).

To find the optimal sine-wave parameters for a frame, a heuristic method based on idealized conditions is typically used. This can be done by using overlapping analysis windows with variable or fixed lengths. A high-resolution Discrete Fourier transform (DFT) is then taken from the windowed signal. For voiced speech the window length should be at least two and one-half times the average pitch period in order to achieve the desired DFT resolution. To determine the frequency of each sinusoidal component, simple peak picking algorithm for the DFT amplitude spectrum is typically used. The amplitude and phase of each sinusoid is then obtained by sampling the high-resolution DFT at these frequencies.

To achieve smoothly evolving synthesized speech signals, proper interpolation of the parameters is used to avoid discontinuities at the frame boundaries between successive frames. For amplitudes, linear interpolation is widely used while the evolving phase is interpolated at high bit rates using a e.g. cubic polynomial between the parameter pairs in the succeeding frames. The interpolated frequency can be computed as a derivative of the phase function. Thus, the resulting model can be defined as

$$\hat{s} ( n ) = {\sum }_{m = 1}^{M} {\hat{A}}_{m} ( n ) cos \text{(} {\hat{θ}}_{m} ( n ) \text{)} , \qquad ( 3 )$$

where Âₘ and \hat{θ}ₘ represent the interpolated amplitude and phase contours.

High-quality phase quantization is very difficult at moderate or even high bit rates. For that reason, most parametric speech coders operating below 6 kbit/s use a linear/random phase model where a speech signal is divided into voiced and unvoiced components. The voiced component is modelled or generated using the linearly evolving phase model, defined by

$$\hat{θ} ( n ) = {θ}^{I} + {ω}^{I} n + ( {ω}^{I + 1} - {ω}^{I} ) \frac{{n}^{2}}{2 N} , \qquad ( 4 )$$

where l and N are frame index and length, respectively. If the frequencies are harmonically related, the phase of ith harmonic is simply i times the phase of the first harmonic.

The unvoiced component is generated by random phase.

By using the linear/random phase model, the synchrony between the original and synthesized speech is lost. In the cubic phase interpolation, the synchrony is maintained only at the frame boundaries. In most parametric speech coders, the voiced and unvoiced components of a speech segment are determined from the DFT of the windowed speech segment. Based on the degree of periodicity of this representation, different frequency bands are classified as voiced or unvoiced. At lower bit rates, a common approach is to define a cut-off frequency classifying all frequencies above the cut-off as unvoiced, and all frequencies below the cut-off as voiced.

Main Properties of Speech Signal

When viewed over a long period of time (>1 s), the speech signal is seen to be highly non-stationary due to a number of factors: the amplitude variations, variations in the vocal tract, active or silence behavior, and voiced or unvoiced behavior. Over a short period of time (10-40 ms), however, speech is locally stationary. The finer characteristics of speech can be observed in both time and frequency domain.

During voiced speech, waveforms exhibit a considerable amount of redundancy. The redundancy can be utilized in speech coding. The redundancy includes: stationarity over short periods of time, periodicity during voiced segments, non-flatness of the short-term spectrum, limitations on the shape and movement rate of the vocal tract, and non-uniform probability distributions of the values representing these parameters.

The unvoiced speech typically resembles band-limited noise.

Based on the speech characteristics, fixed frame sizes do not result in optimal coding efficiency. For example, for smoothly evolving voiced speech the parameter update rate can be significantly smaller than for transient typed speech where the parameter contour varies rapidly. Furthermore, from the quality perspective it would be justified to use more bits in perceptually significant segments (e.g. segments with high energy) and minimize the amount of bits during perceptually unimportant regions (e.g. silence).

To exploit the smooth behavior of the parameters as shown in FIGS. 2b-2d during steady regions of speech, efficient quantization methods are typically used. These methods include prediction and differential coding, for example. However, due to requirements for erroneous channel performance, the efficiency of different coding methods using the statistical distribution of parameters is not fully exploited in current speech coders.

In a typical parametric speech coder, the speech parameters are estimated from the speech signal at regular intervals. The length of this interval is usually equal to the frame length used in the coder. While some parameters (e.g. pitch) may be estimated more often than others, the estimation rate for a given parameter is usually constant. However, it would also be possible to use variable update rates, but the additional complexity and the difficulty of implementation has kept this approach impractical. (see, for example, P. Prandoni and M. Vetterli, “R/D Optimal Linear Prediction”, IEEE Transactions on Speech and Audio Processing, Vol. 8, No. 6, 2000, pp. 646-655.).

The transmission rate for the parameters is typically equal to the estimation rate.

In the quantization of the estimated parameters, the most popular approach is to have a separate quantizer for each parameter and to use the same quantizer for all the estimated values of that parameter. Mode-specific quantizers have also been employed, but this technique is still rather rarely used in practical applications. In mode-specific quantizers, the mode is typically selected based on the voicing information.

In order to achieve encoding and decoding of speech signals at a low bit rate, Aguilar (U.S. Pat. No. 5,787,387) divides the continuous input speech into voiced and unvoiced time segments of a predetermined length. The encoder uses a linear predictive coding (LPC) model for the unvoiced speech segments and harmonic frequencies decomposition for the voiced segments. Only the magnitudes of the harmonic frequencies are determined using the discrete Fourier transform of the voiced speech segments. The decoder synthesizes voiced speech segments using the magnitudes of the transmitted harmonics and estimates the phase of each harmonic form the signal in the preceding speech segments. Unvoiced speech segments are synthesized using LPC coefficients obtained from the code-book entries for the poles of the LPC coefficient polynomial. Boundary conditions between voiced and unvoiced segments are established to insure amplitude and phase continuity for improved output speech quality. In a different approach, Yokoyama (U.S. Patent Application Publication No. 2003/0105624 A1) uses a coding rate selector to select an appropriate speech coding rate according to the power of input speech. The speech coding rate selector has a short-term power arithmetic unit for computing the power of input speech at a predetermined time unit, and an ambient noise power estimating unit for estimating the power of an ambient noise superimposed on the input speech. Based on the result of the ambient noise power estimation, a power threshold value group is computed. The threshold value group is then compared to the power determined by the short-term power arithmetic unit for selecting one appropriate rate from a plurality of the speech coding rates.

Drawbacks of the Prior Art:

The usage of a fixed frame size and fixed parameter transmission rates does not offer the optimal solution, because the value of a given parameter may remain almost constant for a relatively long period in some instants, but the value of the same parameter may fluctuate very fast in other instants.

The properties of the signal to be coded (e.g. voicing information) are not fully exploited in the quantization process.

In parametric speech coding, a fixed parameter update rate is only rarely optimal from the viewpoint of compression efficiency. During the steady (voiced) parts of speech even a very low update rate may be sufficient. However, during noise-like (unvoiced) segments a high update rate is typically required.

The quantization accuracy required for good perceptual accuracy is variable and depends on the properties of the signal to be coded. Thus, the prior-art approach of using a single quantizer with a fixed bit allocation generally either produces perceptually unsatisfactory results during the parts of speech that must be coded very accurately or wastes bits during the portions that could be coded more coarsely.

### SUMMARY OF THE INVENTION

It is a primary object of the present invention to improve the coding efficiency in a speech coding structure for storage applications. In order to achieve this objective, the coding step in which the speech signal is encoded into parameters are adjusted according to the characteristics of the audio signal.

Thus, according to the first aspect of the present invention, there is provided a method of encoding an audio signal having audio characteristics, said method comprising the steps of:
segmenting the audio signal into a plurality of segments based on the audio characteristics of the audio signal; and
   encoding the segments with different encoding settings.

According to the present invention, the segmenting step is carried out concurrent to or before said encoding step.

According to one embodiment of the present invention, a plurality of voicing values are assigned to the voicing characteristics of the audio signal in said segments, and said segmenting is carried out based on the assigned voicing values.

The plurality of values includes a value designated to a voiced speech signal and another value designated to an unvoiced signal. The plurality of values further includes a value designated to a transitional stage between the voice and unvoiced signal. The plurality of values further includes a value designated to an inactive period in the speech signal.

According to one embodiment of the present invention, the method further comprises the step of selecting a quantization mode for said encoding, wherein the segmenting step is carried out based on the selected quantization mode.

According to another embodiment of the present invention, said segmenting step is carried out based on a selected target accuracy in reconstructing of the audio signal.

According to yet another embodiment of the present invention, said segmenting step is carried out for providing a linear pitch representation in at least some of said segments.

The parameters may comprise quantized and unquantized parameters.

According to the second aspect of the present invention, there is provided a decoder for generating a synthesized audio signal indicative of an audio signal having audio characteristics, wherein the audio signal is coded in a coding step into a plurality of parameters at a data rate, and the coding step is adjusted based on the characteristics of the audio characteristics of audio signals for providing an adjusted representation of the parameters. The decoder comprises:
an input for receiving audio data indicative of the parameters in the adjusted representation; and
a module, responsive to the audio data, for generating the synthesized audio signal based on the adjusted representation and the characteristics of the audio signal.

The input of the decoder can be operatively connected to an electronic medium to receive audio data recorded on the electronic medium, or connected to a communication channel to receive audio data transmitted via the communication channel.

According to the third aspect of the present invention, there is provided a coding device for use in conjunction with an audio encoder, the audio encoder encoding an audio signal with audio characteristics for providing a plurality of parameters indicative of the audio signal. The coding device comprises:
an input for receiving audio data indicative of the parameters; and
an adjustment module for segmenting the parameters based on the characteristics of the audio signal for providing an adjusted representation of the parameters.

The coding device further comprises a quantization module, responsive to the adjusted representation, for coding the parameters in the adjusted representation.

The coding device further comprises an output end, operatively connected to a storage medium, for providing data indicative of the coded parameters in the adjusted representation to the storage medium for storage, or operatively connected to a communication channel, for providing signals indicative of the coded parameters in the adjusted representation to the communication channel for transmission.

According to the fourth aspect of the present invention, there is provided a computer software product embodied in an electronically readable medium for use in conjunction with an audio coding device, the audio coding device encoding an audio signal with audio characteristics for providing a plurality of parameters indicative of the audio signal. The computer software product comprises:
a code for determining the characteristics of the audio signal; and
a code for adjusting the parameters based on the characteristics of the audio signal for providing an adjusted representation of the parameters.

According to the fifth aspect of the present invention, there is provided an electronic device, comprising:
a decoder for generating a synthesized audio signal indicative of an audio signal having audio characteristics, wherein the audio signal is coded in a coding step into a plurality of parameters at a data rate, and the coding step is adjusted based on the characteristics of the audio characteristics of audio signals for providing an adjusted representation of the parameters; and an input for receiving audio data indicative of the parameters in the adjusted representation for providing the audio data to the decoder, so as to allow the decoder to generate the synthesized audio signal based on the adjusted representation.

The electronic device can be operatively connected to an electronic medium for receiving the audio data from the electronic medium, or operatively connected to a communication channel for receiving the audio data conveyed via the communication channel.

The electronic device can be a mobile terminal, or a module for terminal.

According to the sixth aspect of the present invention, there is provided a communication network, comprising:
a plurality of base stations; and
a plurality of mobile stations adapted to communicating with the base stations, wherein at least one the mobile stations comprises:
   a decoder for generating a synthesized audio signal indicative of an audio signal having audio characteristics, wherein the audio signal is coded in a coding step into a plurality of parameters at a data rate, and the coding step is adjusted based on the characteristics of the audio characteristics of audio signals for providing an adjusted representation of the parameters; and
      an input for receiving audio data indicative of the parameters in the adjusted representation from at least one of the base stations for providing the audio data to the decoder, so as to allow the decoder to generate the synthesized audio signal based on the adjusted representation.

The present invention will become apparent upon reading the description taken in conjunction with FIGS. 3a to 11.

### BRIEF DESCRIPTION OF THE DRAWINGS

FIG. 1 is a block diagram illustrating a typical digital transmission and storage of speech signals.

FIG. 2a is a time plot showing the waveform of a speech signal.

FIG. 2b is a time plot showing the pitch associated with the speech signal of FIG. 2a.

FIG. 2c is a time plot showing the voicing information associated with the speech signal of FIG. 2a.

FIG. 2d is a time plot showing the energy associated with the speech signal of FIG. 2a.

FIG. 3a is a time plot showing a speech signal for demonstrating the speech signal segmentation method, according to the present invention.

FIG. 3b is a time plot showing the energy in a speech signal associated with the speech signal of FIG. 3a.

FIG. 3c is a time plot showing the voicing information in a speech signal associated with the speech signal of FIG. 3a.

FIG. 3d is a time plot showing the segmentation of speech signal, according to the present invention.

FIG. 4 is a block diagram showing the speech coding system, according to the present invention.

FIG. 5 is a block diagram showing the functional aspect of a speech coder, according to the present invention.

FIG. 6 is a block diagram showing the functional aspect of a decoder, according to the present invention.

FIG. 7 is a flowchart showing the adaptive downsampling and quantization algorithm, according to the present invention.

FIG. 8a is a time plot showing the adaptive bit rate for the gain parameter, as a result from adaptive downsampling, according to the present invention.

FIG. 8b is a time plot showing the adaptive downsampling ratio.

FIG. 8c is a time plot showing the absolute error with respect to the true gain value.

FIG. 8d is a time plot showing the quantization mode.

FIG. 9a is a time plot showing the result of parameter tracking for improving the performance of segmentation.

FIG. 9b is a time plot showing the quantized pitch track, according to an embodiment of the present invention, as compared to the original track.

FIG. 10 is an example of the segment method, according to the present invention.

FIG. 11 is a schematic representation showing a communication network capable of transmitting compressed data to a mobile terminal, according to the present invention.

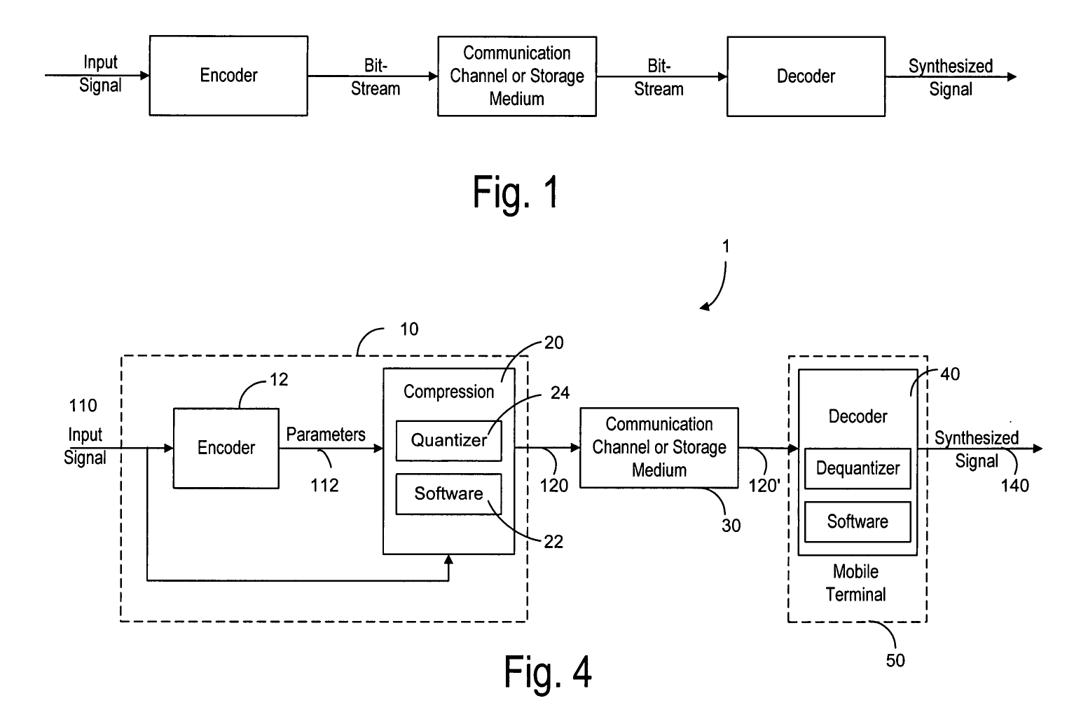

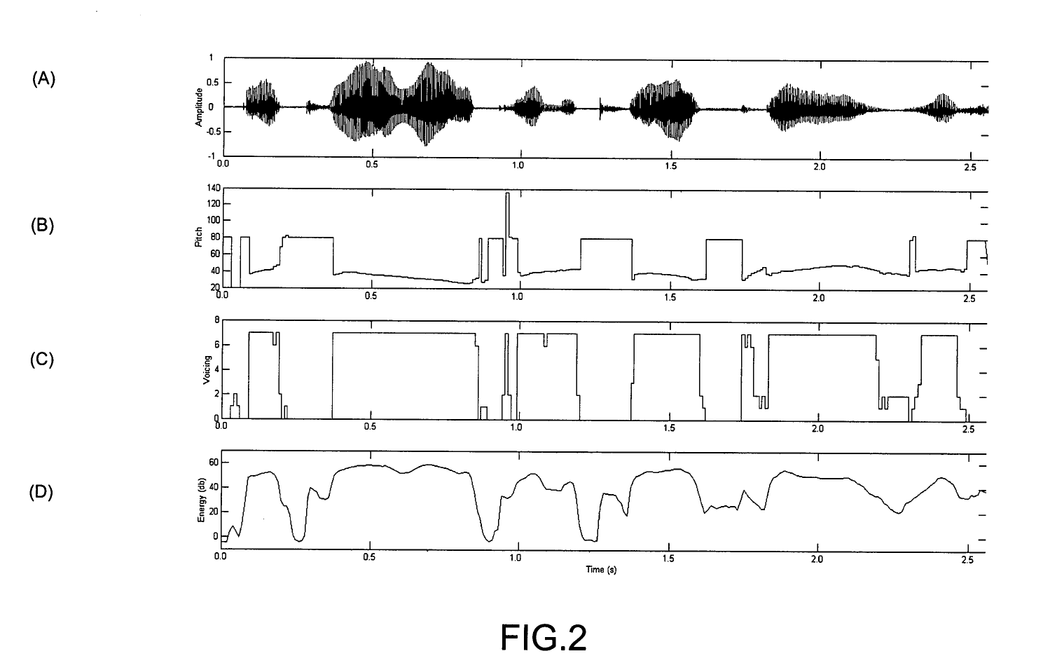

### BEST MODE FOR CARRYING OUT THE INVENTION

In order to reduce the transmission bit rate without significantly reducing the quality of speech, the present invention uses a method of speech signal segmentation for enhancing the coding efficiency of a parametric speech coder. The segmentation is based on a parametric representation of speech. The segments are chosen such that the intra-segment similarity of the speech parameters is high. Each segment is classified into one of the segment types that are based on the properties of the speech signal. Preferably, the segment types are: silent (inactive), voiced, unvoiced and transition (mixed). As such, each segment can be coded by a coding scheme based on the corresponding segment type.

In a typical parametric speech coder, the parameters extracted at regular intervals include linear prediction coefficients, speech energy (gain), pitch and voicing information. To illustrate the speech signal segmentation method of the present invention, it is assumed that the voicing information is given as an integer value ranging from 0 (completely unvoiced) to 7 (completely voiced), and that the parameters are extracted at 10 ms intervals. However, the techniques can be adapted to work with other voicing information types and/or with different parameter extraction rates.

Based on the parameters related to speech energy and voicing, a simple segmentation algorithm can be implemented, for example, by considering the following points:

Silent, inactive segments can be detected by setting a threshold for the energy value. In message pre-recording applications, the audio messages can be adjusted to have a constant input level and the level of background noise can be assumed very low.

The successive parameter extraction instants with an identical voicing value can be set to belong in a single segment.

Any 10-ms segment between two longer segments with the same voicing value can be eliminated as an outlier, such that the three segments can be combined into one long segment. Outliers are atypical data points, which do not appear to follow the characteristic distribution of the rest of the data.

A short (10-20 ms) segment between a completely voiced and a completely unvoiced segment may be merged into one of the neighboring segments if its voicing value is 1 or 2 (merge with the unvoiced segment), or 5 or 6 (merge with the voiced segment).

The successive segments with voicing values in the range from 1 to 6 can be merged into one segment. The type of these segments can be set to ‘transition’.

The remaining single 10-ms segments can be merged with the neighboring segment that has the most similar voicing value.

In addition, it is possible to use the other available parameters in the segmentation. For example, if there is a drastic change in some parameter (e.g. in pitch) during a long voiced segment, the segment can be split into two parts so that the evolution of the parameters remains smooth in both parts.

The coding schemes for the parameters in the different segment types can be designed to meet the perceptual requirements. For example, during voiced segments, high accuracy is required but the update rate can be quite low. During unvoiced segments, low accuracy is often sufficient but the update rate should be high enough.

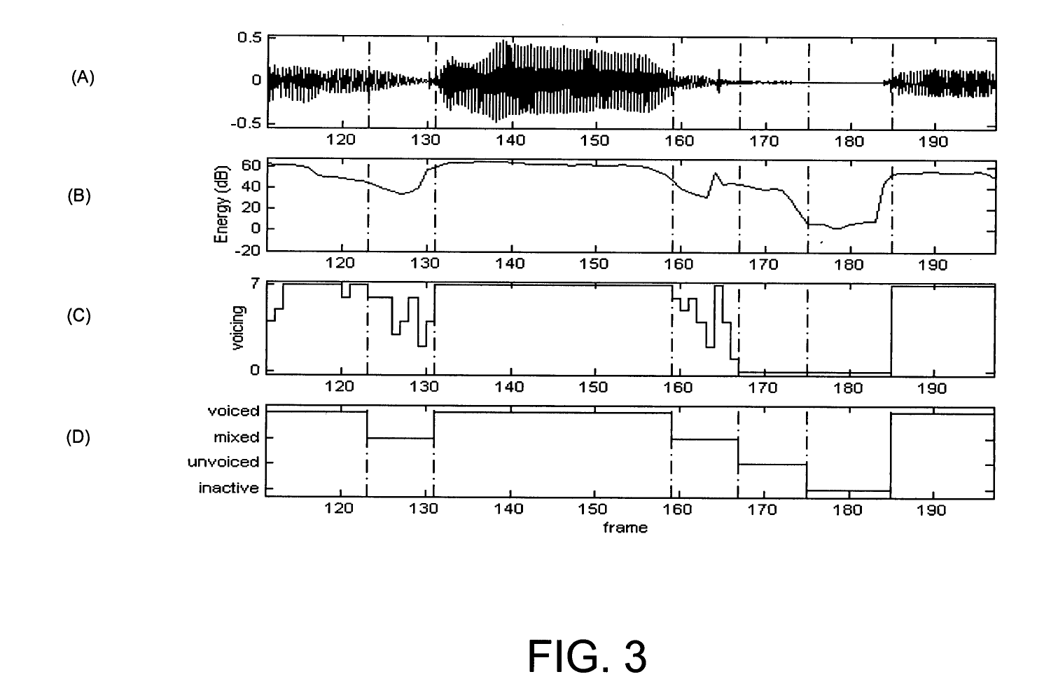

An example of the segmentation is shown in FIGS. 3a-3d. FIG. 3a shows a part of speech signal plotted as a function of time. The corresponding evolution of the energy parameter is shown in FIG. 3b, and the voicing information is shown in FIG. 3c. The segment type is shown in FIG. 3d. The vertical dashed lines in these figures are segment boundaries. In this example the segmentation is based on the voicing and gain parameters. Gain is first used to determine whether frame is active or not (silent). Then the voicing parameter is used to divide active speech to either unvoiced, transition or voiced segments. This hard segmentation can later be redefined with smart filtering and/or using other parameters if necessary. Thus, the segmentation can be made based on the actual parametric speech coder parameters (either unquantized or quantized). Segmentation can also be made based on the original speech signal, but in that case a totally new segmentation block has to be developed.

FIG. 4 is a speech coding system that quantizes speech parameters 112 utilizing the segmentation information. The compression module 20 can use either quantized parameters from an existing speech coder, or the compression module 20 can use the unquantized parameters directly coming from the parameter extraction unit 12. Moreover, a pre-processing stage (not shown) may be added to the encoder to generate speech signals with specific energy level and/or frequency characteristics. The input speech signal 110 can be generated by a human speaker or by a high-quality TTS algorithm. The encoding of the input speech can be done off-line in a computer, for example. The resulting bitstream 120 can be provided to a decoder 40 in a mobile terminal 50, for example, through a communication channel or a storage medium 30. As discussed later, the software program 22 in the compression module 20 can be used to reduce the number of parameters to be coded by the quantizer 24 into a bitstream, so as to allow the decoder 40 to generate a synthesized speech signal based on the parameters in the received bitstream.

Based on the behavior of the parameters (typically pitch, voicing, energy and spectral amplitude information), the compression module 20 carries out, for example, the following steps:
1. Segmentation of the input speech signal.
2. Definition of the optimal parameter update rate for different segments and parameters;
3. Decimation of transmitted parameters from the original parameters.
4. Efficient quantization of the derived parameters.

In general, segmentation of a speech signal may provide the following advantages:

The segmentation (with adaptive segment sizes) enables very high quantization efficiency at very low average bit rates. For example, a pause between two words can be coded using only few bits by quantizing the segment length and indicating that the corresponding segment is of the type ‘silent’.

The segmentation and the inherent look-ahead make it possible to use adaptive parameter transmission rates. Consequently, it is possible to transmit the parameters at perceptually acceptable variable rates.

The coding process can efficiently adapt to changes in the input data as different coding schemes can be used for segments of different types. For example, strong prediction can be used inside voiced segments.

The elimination of single outliers during the segmentation improves the achievable quantization efficiency and may improve the subjective speech quality.

The segmentation procedure is simple and computationally efficient.

The segmentation method can be implemented as an additional block that can be used with existing speech coders.

The speech signal segmentation method can be used in conjunction with an adaptive downsampling and quantization scheme. Both the bit rates and parameter update rates in a parametric speech coder can be adaptively optimized. Optimization is, for example, performed locally on one segment at a time, and the segment length can be fixed or variable. At the encoder side, a typical coder is used to read in a segment of the speech signal and estimate the speech parameters at regular intervals (frames). The process containing segmentation and adaptive downsampling with quantization is carried out in two phases. First, the stream of consecutive frames is divided into continuous segments. The segments are made as long as possible, while still maintaining high intra-segment similarity (e.g. all frames inside a segment are voiced). Second, each segment is quantized using adaptive downsampling, meaning that the lowest possible bit rate and update rate (high decimation factor) enabling high quality is found for each parameter.

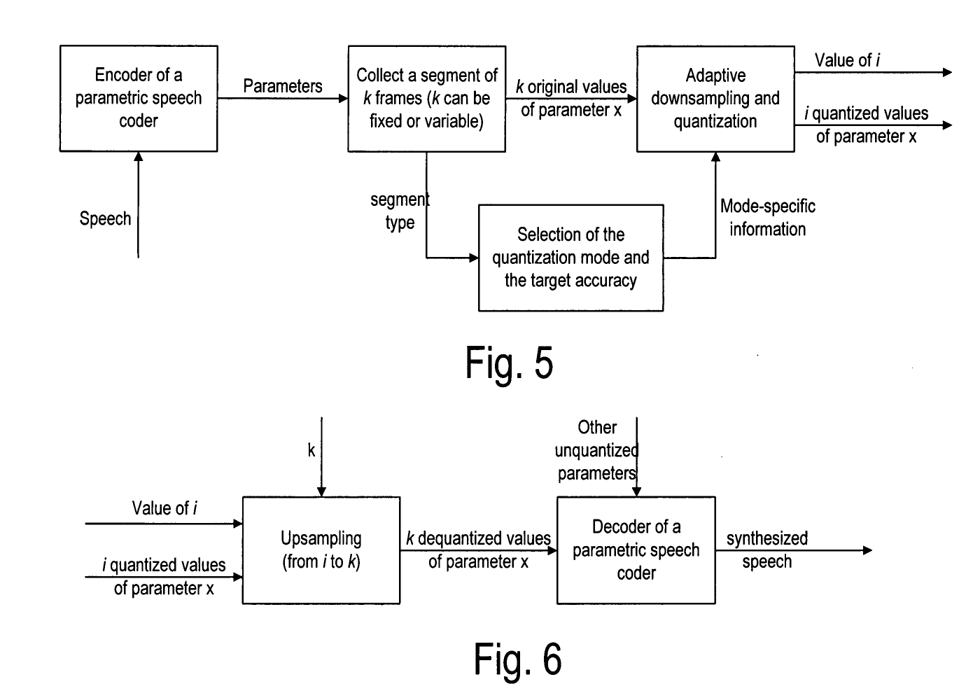

Thus, in the first phase, a compression module (see FIG. 4) gathers together all the k parameter values inside the segment, and forms a “segmented parameter signal” from the successive parameter values. A quantization mode is then selected from the voicing values inside the segment, as illustrated in FIG. 5. Based on the quantization mode, the target accuracy for the coded parametric representation is adaptively defined. The selected accuracy level also determines the number of bits to be used in the quantization of a single parameter value. In the second phase, a down-sampling rate and quantization that just meets the accuracy requirement is selected. In that end, a software program determines a reduced number i of parameter values from the original k parameter values so that only i of the k parameter values are coded by the quantizer into the bitstream.

At the decoder, as shown in FIG. 6, the update rate is converted back to the original update rate using interpolation. The process can be repeated for all the parameters to be transmitted to the decoder.

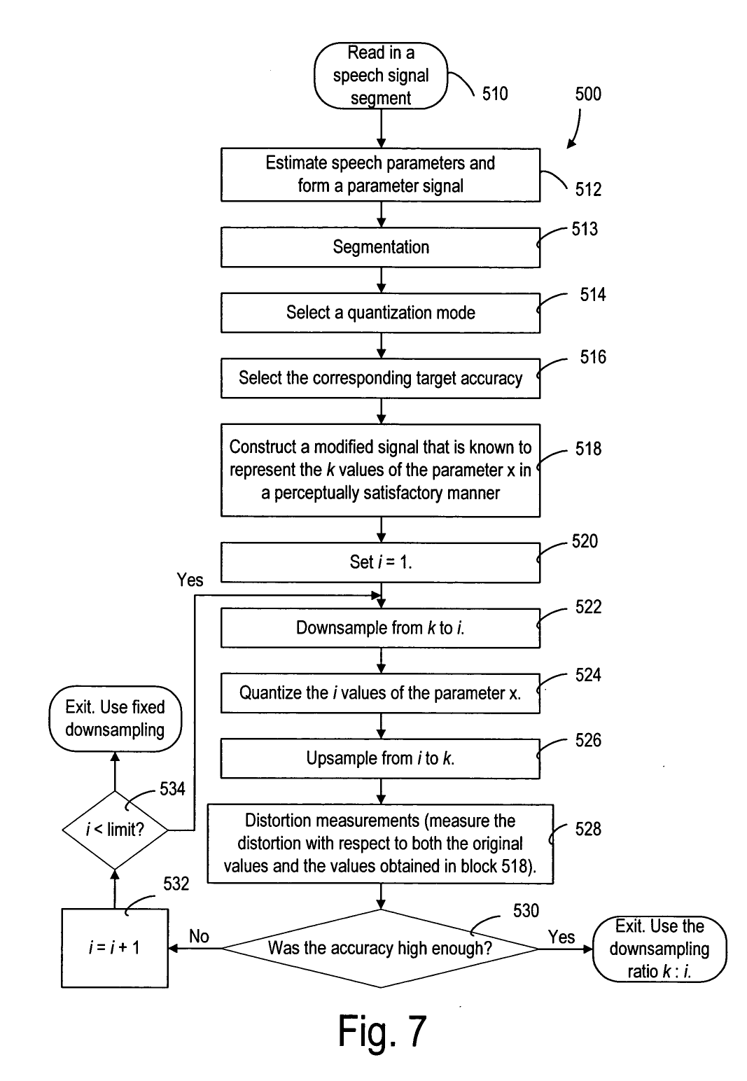

At a more detailed level, the method for adaptive downsampling and quantization of speech parameters is illustrated in the flowchart 500 of FIG. 7. As shown in the flowchart,

a segment of speech signal is read in at step 510. Speech parameters at regular intervals are estimated at step 512. Steps 510 and 512 can be carried out using a typical speech encoder. At step 513, a “segmented parameter signal” is formed from the successive parameter values (all the k parameter values inside the segment are gathered together). At step 514, a quantization mode is selected using the voicing values inside the segment. If the parametric representation does not contain voicing information, an additional voicing classifier can be used to obtain the voicing values. It should be noted that, for best results, the segments should be chosen such that the voicing remains almost constant during the entire segment. At step 516, the target accuracy (and the quantizer) corresponding to the quantization mode is selected. At step 518, a modified signal is formed from the segmented parameter signal of length k. This modified signal has the same length and is known to represent the original signal in a perceptually satisfactory manner. At step 520, the optimization process is started at i=1. At step 522, the parameter signal is downsampled from the length k to the length i. At step 524, use the quantizer selected at step 516 to code the i parameter values. At step 526, the signal with the i quantized parameter values is upsampled to the original length k. At step 528, measure the distortion between the original parameter values and the upsampled quantized values obtained at step 526. In addition, measure the distortion between the upsampled quantized values and the modified parameter signal (see Step 518). At step 530, determine whether the distortion measurements indicate that the target accuracy defined at step 516 is achieved. It is sufficient that one of the two measurements carried out at step 528 conforms to the criteria. If the target accuracy is achieved, i is the number of parameter updates required in this segment. A bitstream is formed by including the value of i and the quantizer indices selected at step 524. (The parameter k is, for example, included in the segment information that is separately transmitted to the decoder). If the target accuracy is not achieved, set i=i+1 at step 532. If i does not exceed its maximum value as determined at step 534, the process continues at step 522. Otherwise, use the fixed update rate that is known to be perceptually sufficient; include this information in the bitstream; quantize the values at the fixed rate; and output the quantizer indices to the bitstream.

At the decoder side, the downsampling ratio is first extracted from the bitstream. Then, the corresponding number of quantizer indices is read from the bitstream and decoded to obtain a set of i quantized values. Finally, the parameter update rate is upsampled back to the original rate using interpolation.

It should be noted that the modified signal selection (at step 518) and the target accuracy assessment (at step 530) are affected by the original rate as well as the perceptually sufficient rate. Let us assume that the estimation rate for the parameter to be coded in 100 Hz and the perceptually sufficient update is 50 Hz (this assumption is valid, for example, for coder implementations regarding storage of pre-recorded audio menus and similar applications). The modified signal can be constructed using a low-pass filter with a cut-off frequency of 0.5π Here, the cut-off frequency is given using the angular frequency notation, in which π corresponds to the Nyquist frequency (i.e. half of the sampling frequency) and this corresponds to anti-alias filtering. Accordingly, the lowest value of i that is just exceeding the maximum (at step 530) is k/2, and fixed downsampling rate is 2:1. The downsampled version can be obtained by using every second value from the filtered signal obtained at step 518.

The distortion measurement carried out at step 528 can be freely selected to fit the needs for the parameter to be coded. Furthermore, the distortion measurement can include more than one result value. For example, it is possible to compute the average weighted squared error and the maximum weighted squared error and to set “accuracy limits” for both values. The adaptive downsampling and quantization method, according to one embodiment of the present invention, has been demonstrated as follows:

The measurement used with the scalar energy parameter is the absolute error in dB and the decoded energy is allowed to deviate from the “true value” by 2 dB. This target accuracy is used regardless of the quantization mode. With the linear prediction coefficients, the spectral distortion is approximated using a weighted squared error measure. Both the maximum and the average error within the segment are measured. The accuracy limits are chosen such that they approximately correspond to the spectral distortion (SD) limited given in Table I.

TABLE I
Accuracy limits used in the coding of
linear prediction coefficients.

| | Unvoiced | Mixed | Voiced |
|---|---|---|---|
| Maximum SD | 4.3 dB | 4.2 dB | 4.1 dB |
| Maximum average SD | 2.1 dB | 1.6 dB | 1.2 dB |

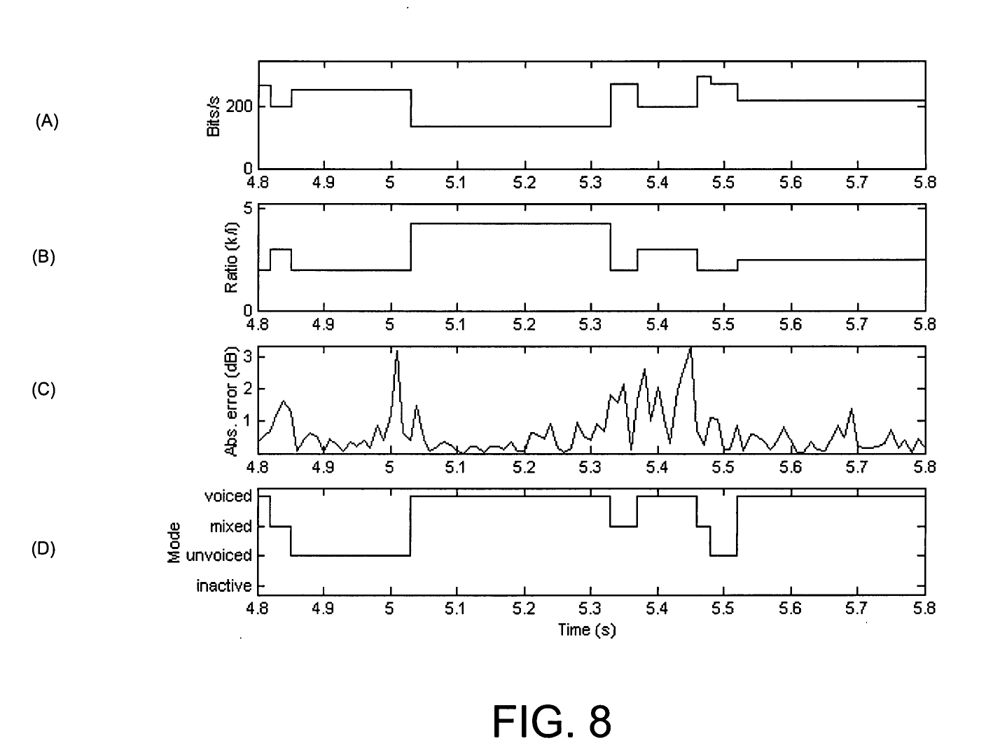

The results of the adaptive downsampling and quantization of the energy parameter are shown in FIGS. 8a to 8d. FIG. 8a shows the evolution of the adaptive bit rate required for the coding of the speech energy during one second of active speech. FIG. 8b depicts the adaptive downsampling ratio, i.e. the value of k divided by the selected value of i. FIG. 8c depicts the corresponding absolute coding error in dB, and FIG. 8d shows the corresponding mode selections. The few errors larger than 2 dB (the accuracy limit) are caused by the use of fixed downsampling. It should be noted that FIGS. 8a to 8d only show a portion of the test sample. For the whole test sample, the average bit rate for the energy parameter is smaller than 150 bps. Without the use of the present invention, the bit rate would be considerably higher. The dynamic range of gain values in the test sample is from about −40 dB to about 70 dB. Accordingly, it can be concluded with direct calculation that a bit rate required to keep the absolute error smaller than 2 dB with the conventional scalar quantization would be 500 bps during active speech.

In sum, speech signals are considered to consist of segments of voiced speech, unvoiced speech, transitions (mixed voiced speech) and pauses (silence). These four types of speech have different physical and perceptual properties. From the quality perspective, it is justified to use more bits during the perceptually significant segments (e.g. segments with high energy) and to minimize the amount of bits during perceptually unimportant regions (e.g. silence). Furthermore, the parameter update rate can be adaptively adjusted according to input speech characteristics.

In order to carry out the present invention, the coder structure includes, for example, one or more of the following components: preprocessing, parameter tracking, segmentation, and adaptive downsampling and quantization. Preprocessing and parameter tracking are typically used for enhancing the performance of the speech coder.

Preprocessing

The input speech signal can be modified in a desired way to increase the coding efficiency since exact reproduction of the original speech is not required. In practice, this means that a pre-processing stage is added to the encoder to generate speech signals with specific energy levels and/or frequency characteristics. In addition, possible background noises can be attenuated.

Parameter Tracking

The performance of the segmentation can be significantly improved with careful processing of the selected parameter tracks. The main target is to remove possible parameter outliers, which may effect the segmentation decisions. This includes e.g. searching pitch detection errors or very short unvoiced segments with low energy, which can be omitted without decreasing the speech quality.

Segmentation

The segmentation can be based either on the parametric representation of speech or on the speech signal itself. The segments are chosen such that the intra-segment similarity of the speech parameters is high. In addition, each segment is classified into one of the segment types that are based on the properties of the speech signal (the segment types are silent, voiced, unvoiced, and transition). As a result of this segmentation technique, each segment can be efficiently coded using a coding scheme designed specifically for the corresponding segment type. An example of such coding schemes are presented in Table II and Table III. Table II shows the quantization accuracy required for typical speech parameters while perceptually sufficient update rates are listed in Table III.

TABLE II
Quantization accuracy required for
typical parameters during different segments.

| | Voiced | Mixed | Unvoiced | Silence |
|---|---|---|---|---|
| Spectrum | high | high | low | — |
| Gain | high | high | low | low/— |
| Pitch | high | high | — | — |
| Voicing | — | low | — | — |

TABLE III
Perceptually sufficient update rates for
typical parameters during different segments.

| | Voiced | Mixed | Unvoiced | Silence |
|---|---|---|---|---|
| Spectrum | low | high | high | — |
| Gain | low | high | high | low/— |
| Pitch | low | high | — | — |
| Voicing | — | high | — | — |

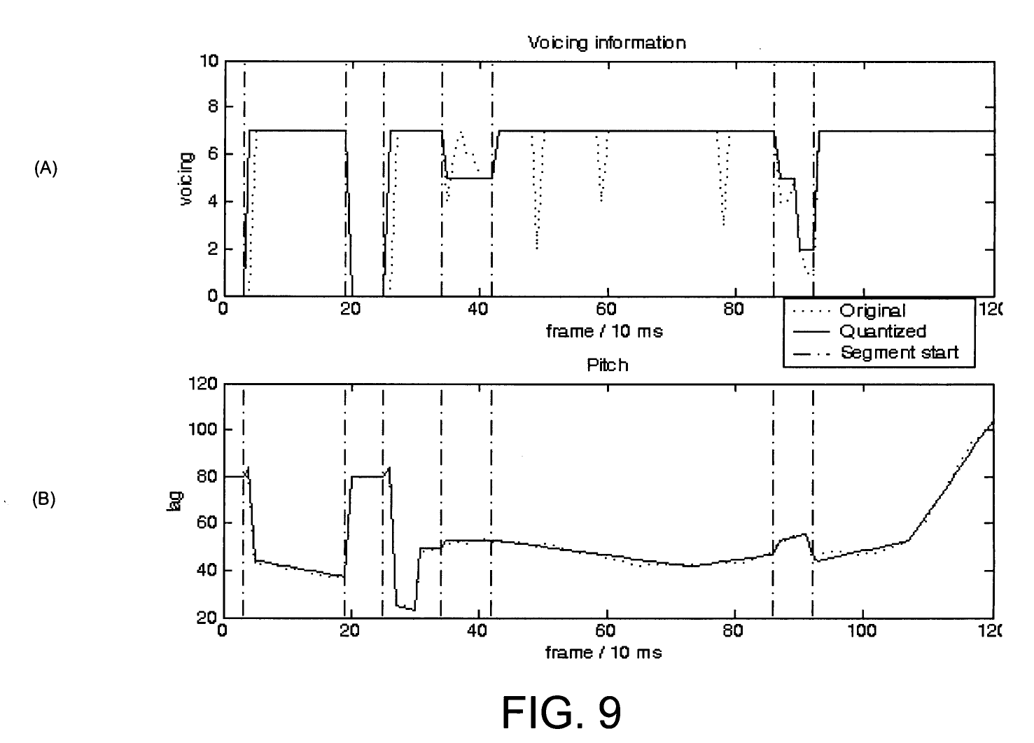

To further improve the coding efficiency, the initial segmentation can be modified using backward and forward tracking. For example, very short unvoiced segments between two voiced segments can be eliminated as outliers (the three segments can be combined into one long segment). This tracking approach is illustrated in FIG. 9a where it can be seen how single voicing outlier peaks are removed. As a consequence, the average segment length is increased which in turn improves the quantization performance.

Adaptive Downsampling and Quantization

The adaptive downsampling and quantization can be performed for one segment of speech at a time and within each segment the process is, for example, gone through in two phases. First, the target accuracy for the coded parametric representation is adaptively defined based on the properties of the corresponding speech signal. The selected accuracy level also determines the number of bits to be used in the quantization of a single parameter value. Then, a downsampling rate that just meets the accuracy requirement is selected. At the decoder, the update rate is converted back to the original update rate using interpolation. The process can be repeated for all the parameters to be transmitted to the decoder. With this technique, the average bit rate can be kept very small although the quantized parameter track approximates the original track quite well. This is illustrated in FIG. 9b: the quantized pitch track is quite close to the original track although the bit rate drops from 700 bps to about 100 bps.

The adaptive downsampling and quantization scheme significantly increases the coding efficiency when compared to conventional approaches with fixed bit allocations and parameter update rates. The improvement can be achieved because both the parameter update rate and the bit rate are locally optimized for short segments of speech, individually for each parameter. Consequently, the update rate and the bit rate can always be kept as low as possible while still maintaining an adequate perceptual quality. During sensitive portions of speech, a sufficiently high update rate and/or bit rate can be temporarily used without significantly increasing the average bit rate.

Again, the utilities of the present invention includes:
Enhanced coding efficiency when compared to the prior art.
The bit allocation is adaptively adjusted to fit the accuracy required for perceptually accurate representation.
The parameter update rates are adaptively adjusted to constantly find a good balance between the bit rate and the accuracy of the resulting parametric representation.
The update rates and the bit rates can be optimized individually for every parameter.
The invention can be implemented as an additional block that can be used with existing speech coders.

The adaptive downsampling and quantization of speech parameters, according to the present invention, can be implemented in many different ways. One of such ways has been described in conjunction with FIGS. 5 to 7. However, the up and downsamplings can be carried out in many ways. Furthermore, the existing implementation uses discrete cosine transform (DCT) and inverse DCT but there are also many other alternatives. Similarly, it is possible to achieve faster search for the correct i by using binary search instead of the linear search. This approach gives a good trade-off between the performance and complexity. Also, it has the additional advantage in that the invention can be implemented as an additional block that supplements an existing parametric speech coder. Moreover, the parameter estimation rate at the encoder can be variable or fixed to a rate different than the one used in the decoder. This approach can be used in cases where the parameter update rate at the decoder is not equal to the parameter update rate used in the encoder.

Alternatively, adaptive downsampling and quantization can be carried out where the adaptive update rate is selected already during the parameter estimation. Theoretically, this approach yield the best result but the associated complexity is rather burdensome. In yet another approach, the downsampling rate is defined without knowledge of the quantizer. This has the lowest complexity but the performance is not as high as other approaches.

As demonstrated above, the adaptive down-sampling and quantization scheme significantly increases the coding efficiency when compared to conventional approaches with fixed bit allocations and parameter update rates. With the present invention, both the parameter update rate and the bit rate are locally optimized for short segments of speech, individually for each parameter. Consequently, the update rate and the bit rate can always be kept as low as possible while still maintaining an adequate perceptual quality. During sensitive portions of speech, a sufficiently higher update rate and/or bit rate can be temporarily used without significantly increasing the average bit rate.

It should be noted that the parametric speech coding model described in the background section is a sinusoidal model, but there are other parametric speech coding models. The present invention is applicable to the sinusoidal model and other parametric speech models as well.

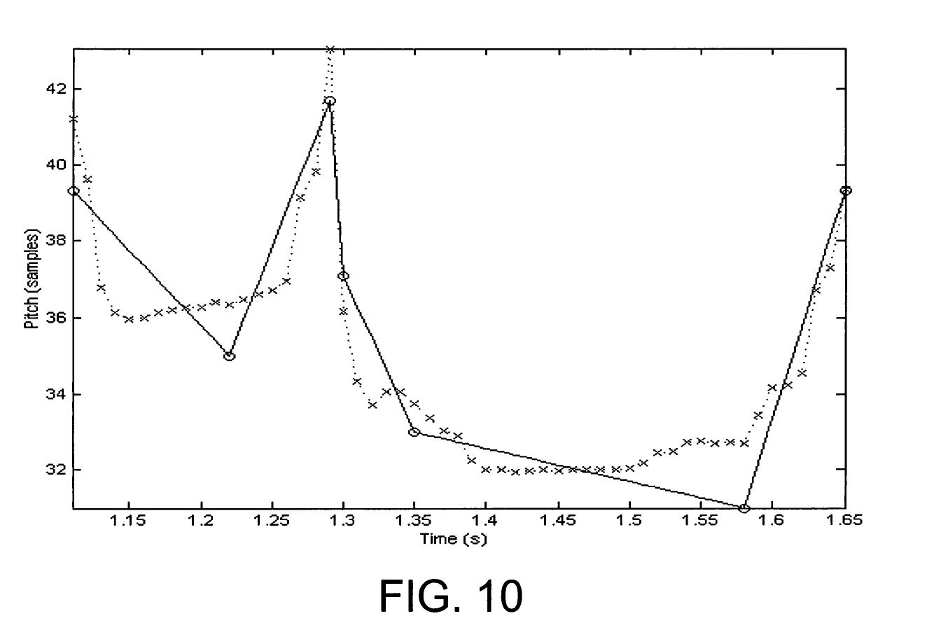

An example of the parametric compression and segmentation, according to the present invention, is the subject of a related U.S. patent application Docket Number 944-003.191, entitled “Method and System for Pitch Contour Quantization in Speech Coding”. More particularly, U.S. patent application Docket Number 944-003.191 describes a piece-wise pitch contour quantization method. An example of the piece-wise pitch contour is shown in FIG. 10. The piece-wise pitch contour can have linear or non-linear contour segments. With a piece-wise linear pitch contour, only those points of the contour where there are derivative changes are transmitted to the decoder. Accordingly, the update rate required for the pitch parameter is significantly reduced. In principle, the piece-wise linear contour is constructed in such a manner that the number of derivative changes is minimized while maintaining the deviation from the “true pitch contour” below a pre-specified limit.

A simple but efficient optimization technique for constructing the piece-wise linear pitch contour can be obtained by going through the process one linear segment at a time, as briefly described below.

For each linear segment, the maximum length line (that can keep the deviation from the true contour low enough) is searched without using knowledge of the contour outside the boundaries of the linear segment. Within this optimization technique, there are two cases that have to be considered: the first linear segment and the other linear segments.

The case of the first linear segment occurs at the beginning when the encoding process is started. In addition, if no pitch values are transmitted for inactive or unvoiced speech, the first segment after these pauses in the pitch transmission fall to this category. In both situations, both ends of the line can be optimized. Other cases fall in to the second category in which the starting point for the line has already been fixed and only the location of the end point can be optimized.

In the case of the first linear segment, the process is started by selecting the first two pitch values as the best end points for the line found so far. Then, the actual iteration is started by considering the cases where the ends of the line are near the first and the third pitch values. The candidates for the starting point for the line are all the quantized pitch values that are close enough to the first original pitch value such that the criterion for the desired accuracy is satisfied. Similarly, the candidates for the end point are the quantized pitch values that are close enough to the third original pitch value. After the candidates have been found, all the possible start point and end point combinations are tried out: the accuracy of linear representation is measured at each original pitch location and the line can be accepted as a part of the piece-wise linear contour if the accuracy criterion is satisfied at all of these locations. Furthermore, if the deviation between the current line and the original pitch contour is smaller than the deviation with any one of the other lines accepted during this iteration step, the current line is selected as the best line found so far. If at least one of the lines tried out is accepted, the iteration is continued by repeating the process after taking one more pitch value to the segment. If none of the alternatives is acceptable, the optimization process is terminated and the best end points found during the optimization are selected as points of the piece-wise linear pitch contour.

In the case of other segments, only the location of the end point can be optimized. The process is started by selecting the first pitch value after the fixed starting point as the best end point for the line found so far. Then, the iteration is started by taking one more pitch value into consideration. The candidates for the end point for the line are the quantized pitch values that are close enough to the original pitch value at that location such that the criterion for the desired accuracy is satisfied. After finding the candidates, all of them are tried out as the end point. The accuracy of linear representation is measured at each original pitch location and the candidate line can be accepted as a part of the piece-wise linear contour if the accuracy criterion is satisfied at all of these locations. In addition, if the deviation from the original pitch contour is smaller than with the other lines tried out during this iteration step, the end point candidate is selected as the best end point found so far. If at least one of the lines tried out is accepted, the iteration is continued by repeating the process after taking one more pitch value to the segment. If none of the alternatives is acceptable, the optimization process is terminated and the best end point found during the optimization is selected as a point of the piece-wise linear pitch contour.

In both cases described above in detail, the iteration can be finished prematurely for two reasons. First, the process is terminated if no more successive pitch values are available. This may happen if the whole lookahead has been used, if the speech encoding has ended, or if the pitch transmission has been paused during inactive or unvoiced speech. Second, it is possible to limit the maximum length of a single linear part in order to code the point locations more efficiently. After finding a new point of the piece-wise linear pitch contour, the point can be coded into the bitstream. Two values must be given for each point: the pitch value at that point and the time-distance between the new point and the previous point of the contour. Naturally, the time-distance does not have to be coded for the first point of the contour. The pitch value can be conveniently coded using a scalar quantizer.

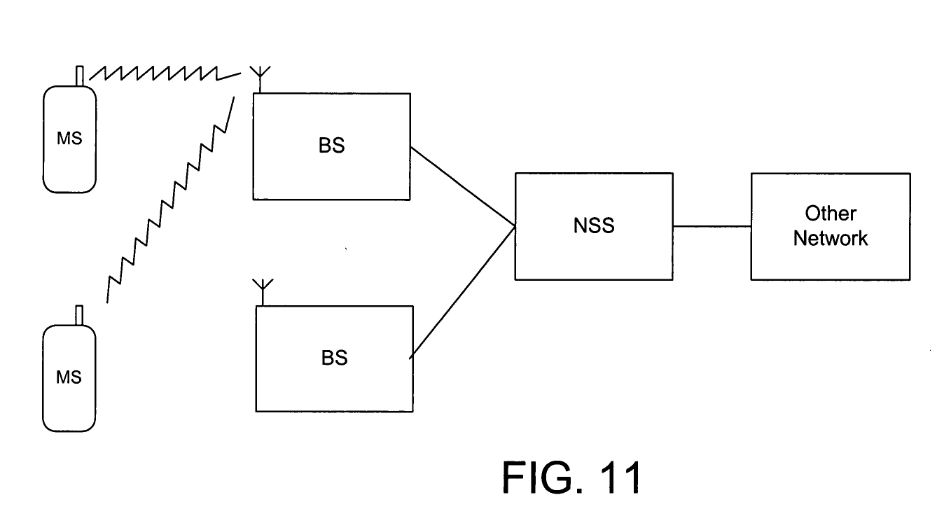

FIG. 11 is a schematic representation of a communication network that can be used for coder implementation regarding storage of pre-recorded audio menus and similar applications, according to the present invention. As shown in the figure, the network comprises a plurality of base stations (BS) connected to a switching sub-station (NSS), which may also be linked to other network. The network further comprises a plurality of mobile stations (MS) capable of communicating with the base stations. The mobile station can be a mobile terminal, which is usually referred to as a complete terminal. The mobile station can also be a module for terminal without a display, keyboard, battery, cover etc. The mobile station may have a decoder 40 for receiving a bitstream 120 from a compression module 20 (see FIG. 4). The compression module 20 can be located in the base station, the switching sub-station or in another network.

Although the invention has been described with respect to a preferred embodiment thereof, it will be understood by those skilled in the art that the foregoing and various other changes, omissions and deviations in the form and detail thereof may be made without departing from the scope of this invention.

1. A method of encoding an audio signal having audio characteristics, said method comprising the steps of:
segmenting the audio signal into a plurality of segments based on the audio characteristics of the audio signal; and
encoding the segments with different encoding settings.

2. The method of claim 1, wherein said adjusting comprises the step of segmenting the audio signal into a plurality of segments based on the characteristics of the audio signal.

3. The method of claim 2, wherein the characteristics include voicing characteristics in said segments of the audio signal.

4. The method of claim 2, wherein the characteristics include energy characteristics in said segments of the audio signals.

5. The method of claim 2, wherein the characteristics include pitch characteristics in said segments of the audio signals.

6. The method of claim 1, wherein said segmenting is carried out concurrent to said encoding step.

7. The method of claim 1, wherein said segmenting is carried out after said encoding step.

8. The method of claim 3, wherein a plurality of voicing values are assigned to the voicing characteristics of the audio signal in said segments, and wherein said segmenting is carried out based on the assigned voicing values.

9. The method of claim 8, wherein the plurality of values includes a value designated to a voiced speech signal and another value designated to an unvoiced signal.

10. The method of claim 8, wherein the plurality of values further includes a value designated to a transitional stage between the voice and unvoiced signal.

11. The method of claim 8, wherein the plurality of values further includes a value designated to an inactive period in the speech signal.

12. The method of claim 1, further comprising the step of selecting a quantization mode for said encoding, wherein the segmenting step is carried out based on the selected quantization mode.

13. The method of claim 1, wherein said segmenting step is carried out based on a selected target accuracy in reconstructing of the audio signal.

14. The method of claim 5, wherein said segmenting step is carried out for providing a linear pitch representation in at least some of said segments.

15. The method of claim 1, wherein the audio signal is encoded into audio signal data, said method further comprising the steps of
forming a parameter signal based on the audio signal data having a first number of signal data;
downsampling the parameter signal to a second number of signal data for providing a further parameter signal, wherein the second number is smaller than the first number; and
upsampling the further parameter signal to a third number of signal data in decoding, wherein the third number is greater than the second number.

16. The method of claim 15, wherein the third number is equal to the first number.

17. The method of claim 15, wherein the signal data comprise quantized parameters.

18. The method of claim 15, wherein the signal data comprises unquantized parameters.

19. A decoder for generating a audio signal indicative of an audio signal having audio characteristics, wherein the audio signal is coded in a coding step into a plurality of parameters at a data rate, and the coding step is adjusted based on the characteristics of the audio characteristics of audio signals for providing an adjusted representation of the parameters, said decoder comprising:
an input for receiving audio data indicative of the parameters in the adjusted representation; and
a module, responsive to the audio data, for generating the audio signal based on the adjusted representation and the characteristics of the audio signal.

20. The decoder of claim 19, wherein the audio data is recorded on an electronic medium, and wherein input of the decoder is operatively connected to the electronic medium for receiving the audio data.

21. The decoder of claim 19, wherein the audio data is transmitted through a communication channel, and wherein the input of the decoder is operatively connected to the communication channel for receiving the audio data.

22. A coding device for encoding an audio signal with audio characteristics the coding device comprising:
an input for receiving audio data indicative of the characteristics; and
an adjustment module for adjusting the parameters based on the characteristics of the audio signal for providing an adjusted representation of the parameters.

23. The coding device of claim 22, further comprising a quantization module, responsive to the adjusted representation, for coding the parameters in the adjusted representation.

24. The coding device of claim 22, further comprising an output end, operatively connected to a storage medium, for providing data indicative of the coded parameters in the adjusted representation to the storage medium for storage.

25. The coding device of claim 22, further comprising an output end, operatively connected to a communication channel, for providing signals indicative of the coded parameters in the adjusted representation to the communication channel for transmission.

26. A computer software product embodied in an electronically readable medium for use in conjunction with an audio coding device, the audio coding device encoding an audio signal with audio characteristics for providing a plurality of parameters indicative of the audio signal, said computer software product comprising:
a code for determining the characteristics of the audio signal; and
a code for adjusting the parameters based on the characteristics of the audio signal for providing an adjusted representation of the parameters.

27. An electronic device comprising:
a decoder for generating a synthesized audio signal indicative of an audio signal having audio characteristics, wherein the audio signal is coded in a coding step into a plurality of parameters at a data rate, and the coding step is adjusted based on the characteristics of the audio characteristics of audio signals for providing an adjusted representation of the parameters; and an input for receiving audio data indicative of the parameters in the adjusted representation for providing the audio data to the decoder, so as to allow the decoder to generate the synthesized audio signal based on the adjusted representation.

28. The electronic device of claim 27, wherein the audio data is recorded in an electronic medium, and wherein the input is operatively connected to the electronic medium for receiving the audio data.

29. The electronic device of claim 27, wherein the audio data is conveyed through a communication channel, and wherein the input is operatively connected to the communication channel for receiving the audio data.

30. The electronic device of claim 27, comprises a mobile terminal.

31. A communication network, comprising:
a plurality of base stations; and
a plurality of mobile stations adapted to communicating with the base stations, wherein at least one the mobile stations comprises:
a decoder for generating a synthesized audio signal indicative of an audio signal having audio characteristics, wherein the audio signal is coded in a coding step into a plurality of parameters at a data rate, and the coding step is adjusted based on the characteristics of the audio characteristics of audio signals for providing an adjusted representation of the parameters; and
an input for receiving audio data indicative of the parameters in the adjusted representation from at least one of the base stations for providing the audio data to the decoder, so as to allow the decoder to generate the synthesized audio signal based on the adjusted representation.

32. A decoder for reconstructing an audio signal, wherein the audio signal is encoded for providing parameters indicative of the audio signal, the parameters including pitch contour data containing a plurality of pitch values representative of an audio segment in time, and wherein the pitch contour data in the audio segment in time is approximated by a plurality of consecutive sub-segments in the audio segment, each of said sub-segments defined by a first end point and a second end point, said decoder comprising:
an input for receiving audio data indicative of the end points defining the sub-segments; and
a reconstruction module for reconstructing the audio segment based on the received audio data.
